(19) United States
(12) Patent Application Publication
(10) Pub. No.: US 2009/0115849 A1
(43) Pub. Date: May 7, 2009

(54) Controlling A Point Of Sale ('POS') Terminal Using Surveillance Video

(75) Inventors: John D. Landers, Jr., Raleigh, NC (US); David J. Steiner, Raleigh, NC (US); Paul M. Wilson, Cary, NC (US); Kimberly A. Wood, Raleigh, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATION BUSINESS MACHINES CORPORATION, ARMONK, NY (US)

(21) Appl. No.: 11/936,112

(22) Filed: Nov. 7, 2007

(51) Int. Cl. H04N 7/00

(52) U.S. Cl. 348/150; 348/E07.001

(57) ABSTRACT

Methods, apparatus, and products are disclosed for controlling a Point Of Sale (‘POS’) terminal using surveillance video that include: receiving, by a surveillance module, a digital surveillance video of a region adjacent to a POS terminal, the digital surveillance video captured by a digital surveillance camera; identifying, by the surveillance module in dependence upon the digital surveillance video, operator characteristics for an operator captured on the digital surveillance video in the region adjacent to a POS terminal; and administering, by the surveillance module, the POS terminal in dependence upon the operator characteristics.

### BACKGROUND OF THE INVENTION

1. Field of the Invention

The field of the invention is data processing, or, more specifically, methods, apparatus, and products for controlling a Point Of Sale (‘POS’) terminal using surveillance video.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems and networks today that are much more ubiquitous and powerful than just a few years ago.

One of the most prevalent uses of these powerful computer systems and networks is for Point Of Sale (‘POS’) systems in retail establishments such as, for example, stores, restaurants, hotels, stadiums, casinos, and so on. Modern POS systems typically include one or more POS terminals connected to a POS server that aggregates and administers POS transaction data. Each POS terminal is typically located on a checkout counter and used by an operator to complete customer sales. Each POS terminal is a computing device that typically includes a cash register, check/debit card/credit card reader, bar code reader or radio frequency identification (‘RFID’) chip reader, and so on. The POS terminals communicate over a network to various external transaction systems such as, for example, credit card processing systems, debit card processing systems, check processing systems, and so on.

To minimize the risk of financial loss to retail stores due to employee or customer theft, retail establishments commonly employ the use of surveillance cameras near POS terminals. These cameras are typically used for back room manual surveillance of the operator of the POS terminal during transaction in an effort to detect unscrupulous actions on the part of the operator such as, for example, not scanning certain items allegedly being purchased by an accomplice, giving excess cash to an accomplice, and so on. Furthermore, it is typical that surveillance cameras are digitally attached to servers in a computer room in the back of the retail store. The digital surveillance video produced by the surveillance cameras are aggregated and stored on such servers for on-site surveillance monitoring or remote monitoring over an existing network.

### SUMMARY OF THE INVENTION

Methods, apparatus, and products are disclosed for controlling a Point Of Sale (‘POS’) terminal using surveillance video that include: receiving, by a surveillance module, a digital surveillance video of a region adjacent to a POS terminal, the digital surveillance video captured by a digital surveillance camera; identifying, by the surveillance module in dependence upon the digital surveillance video, operator characteristics for an operator captured on the digital surveillance video in the region adjacent to a POS terminal; and administering, by the surveillance module, the POS terminal in dependence upon the operator characteristics.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary system capable of controlling a POS terminal using surveillance video according to embodiments of the present invention.

FIG. 2 sets forth a flow chart illustrating an exemplary method of controlling a POS terminal using surveillance video according to embodiments of the present invention.

FIG. 3 sets forth a flow chart illustrating a further exemplary method of controlling a POS terminal using surveillance video according to embodiments of the present invention.

FIG. 4 sets forth a flow chart illustrating a further exemplary method of controlling a POS terminal using surveillance video according to embodiments of the present invention.

### DETAILED DESCRIPTION OF EXEMPLARY EMBODIMENTS

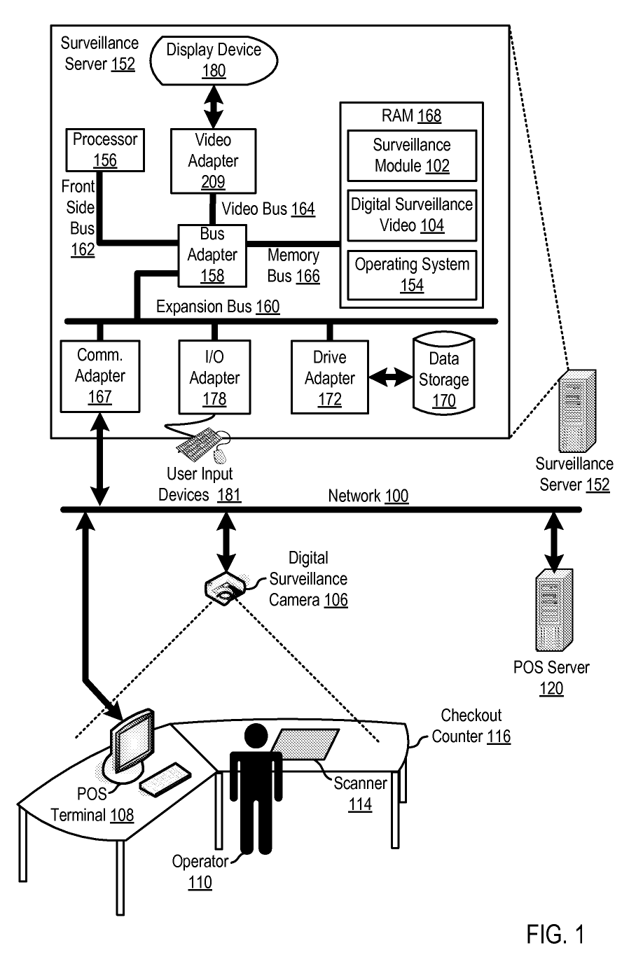

Exemplary methods, apparatus, and products for controlling a POS terminal using surveillance video in accordance with the present invention are described with reference to the accompanying drawings, beginning with FIG. 1. FIG. 1 sets forth a functional block diagram of an exemplary system capable of controlling a POS terminal using surveillance video according to embodiments of the present invention. The exemplary system of FIG. 1 includes a surveillance server (152), a digital surveillance camera (106), a POS terminal (108), and a POS server (120) connected together for data communications through a network (100).

The exemplary POS terminal (108) of FIG. 1 is a computing device used by an operator (110) to complete transactions at a checkout counter (116). The POS terminal (108) of FIG. 1 includes user input devices such as, for example, a keyboard, touch screen, microphone, and so on. The POS terminal (108) also includes a scanner (114) capable of identifying items using a barcode or RFID tag. In the example of FIG. 1, the POS terminal (108) is connected to the POS server (120) through a data communications network (100). Readers will note that the configuration of the POS terminal (108) in FIG. 1 is for explanation only and not for limitation. In fact, other POS terminal configurations as will occur to those of ordinary skill in the art may also be useful in embodiments of the present invention. Examples of POS terminals that may be improved for controlling a POS terminal using surveillance video according to embodiments of the present invention include Toshiba's ST-7000 Modular POS Terminal, IBM's SurePOS™ 700 series of POS terminals, NCR's 7452-3500 POS terminal, and so on.

The POS server (120) of FIG. 1 is a computing device that manages one or more POS terminals. The POS server (120) of FIG. 1 aggregates and administers POS transaction data received from and provided to each of the POS terminals. In the example of FIG. 1, the POS server (120) may serve as a gateway through which all POS transaction data passes before being processes by other external payment processing systems such as, for example, check processing systems, debit card processing systems, credit card processing systems, and so on. In other embodiments, however, each POS terminal may communicate through a network directly with various external payment processing systems and provide the results of those communications to the POS server (120) for storage. In still further embodiments, the POS terminal may be a stand-alone unit that does not rely on a POS server.

The exemplary surveillance server (152) of FIG. 1 includes a surveillance module (102) stored in RAM (168). The surveillance module (102) is a software component having computer program instructions for controlling a POS terminal using surveillance video according to embodiments of the present invention. The surveillance module (102) operates generally for controlling a POS terminal using surveillance video according to embodiments of the present invention by: receiving a digital surveillance video (104) of a region adjacent to a POS terminal (108), the digital surveillance video (104) captured by a digital surveillance camera (106); identifying, in dependence upon the digital surveillance video (104), operator characteristics for the operator (110) captured on the digital surveillance video in the region adjacent to the POS terminal (108); and administering the POS terminal (108) in dependence upon the operator characteristics.

The digital surveillance camera (106) of FIG. 1 is a computing device that captures video images, and optionally captures audio, and stores the captured video images and audio as a digital surveillance video (104) onto a storage medium. The storage medium may include, for example, flash memory, video tape, a disk drive, or any other storage medium as will occur to those of skill in the art. In the example of FIG. 1, the digital surveillance camera (106) also includes electronic components and software capable of packetizing the digital surveillance video (104) and transmitting the digital surveillance video (104) to the surveillance server (152).

The format in which the digital surveillance camera (106) encodes video images and audio to create the digital surveillance video (104) of FIG. 1 may vary depending on the codec used by the surveillance camera (106). ‘Codec’ is an industry-standard term referring to ‘encoder/decoder.’ A codec is a software component capable of encoding a digital video for transmission, storage or encryption and decoding a digital video for analysis, display or editing. Although the codec may be implemented as a software component, such an implementation is for explanation and not for limitation. In fact, a codec may also be implemented as computer hardware. Examples of codecs useful in controlling a POS terminal using surveillance video according to embodiments of the present invention may include Cinepak, Motion JPEG, MPEG, and any other codecs as will occur to those of skill in the art.

The digital surveillance video (104) of FIG. 1 represents a collection of digital frames typically used to create the illusion of a moving picture. In addition, the digital surveillance video (104) of FIG. 1 may include any audio that may have been captured by the digital surveillance camera or separately installed microphones. Each frame of digital surveillance video (104) includes image data for rendering one still image and metadata associated with the image data. The metadata of each frame may include synchronization data for synchronizing the frame with an audio stream, configurational data for devices displaying the frame, and so on. A display device is typically used to display the digital surveillance video (104) by flashing each frame on the display screen for a brief period of time, typically 1/24th, 1/25th or 1/30th of a second, and then immediately replacing the frame displayed on the display screen with the next frame of the digital surveillance video (104). As a person views the display screen, persistence of vision in the human eye blends the displayed frames together to produce the illusion of a moving image.

Operator characteristics describe attributes of the operator (110) captured on the digital surveillance video (104) or describe the operator's activity captured on the digital surveillance video (104). For example, operator characteristics may describe the operator's clothing, the operator's size or shape or other biometric features of the operator. Other exemplary operator characteristics may also include motions made by the operator such as hand motions, body repositioning, or other actions performed by the operator.

Using the operator characteristics identified by the surveillance module (102) in the example of FIG. 1, the surveillance module (102) may administer the POS terminal (108) by controlling power to the POS terminal (108). For example, when the operator characteristics indicate that the operator approaches the POS terminal (108), the surveillance module (102) may turn on power to the POS terminal (108). Similarly, when the operator characteristics indicate that the operator leaves the POS terminal (108), the surveillance module (102) may turn off power to the POS terminal (108). In the example of FIG. 1, the ability to turn on power to the POS terminal (108) through the network (100) may be provided through a powered network port in the POS terminal (108) that receives a wakeup packet from the surveillance module (102).

In example of FIG. 1, the digital surveillance camera (106) is mounted above the POS terminal (108) and communicates with a surveillance server (152) typically installed in a computer room of the retail establishment. The surveillance module (102) installed on the surveillance server (152) then controls the POS terminal (108) through the network (108) according to embodiments of the present invention. Readers will note, however, that such an example is for explanation only and not for limitation. In some other embodiments, the digital surveillance camera (106) may be mounted on the POS terminal (106). In such embodiments, the digital surveillance camera (106) may be directly connected to the POS terminal (108), and the surveillance module (102) may be installed and executed on the digital surveillance camera (106). Furthermore, readers will also appreciate other configurations as will occur to those of skill in the art.

Also stored in surveillance server's RAM (168) is an operating system (154). Operating systems useful for controlling a POS terminal using surveillance video according to embodiments of the present invention include UNIX™, Linux™, Microsoft Vista™, AIX™, IBM's i5/OS™, and others as will occur to those of skill in the art. The operating system (154), the surveillance module (102), and the digital surveillance video (104) in the example of FIG. 1 are shown in RAM (168), but many components of such software typically are stored in non-volatile memory also, such as, for example, on a disk drive (170).

The exemplary surveillance server (152) of FIG. 1 includes disk drive adapter (172) coupled through expansion bus (160) and bus adapter (158) to processor (156) and other components of the surveillance server (152). Disk drive adapter (172) connects non-volatile data storage to the surveillance server (152) in the form of disk drive (170). Disk drive adapters useful in computing devices for controlling a POS terminal using surveillance video according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (‘EEPROM’ or ‘Flash’ memory), RAM drives, and so on, as will occur to those of skill in the art.

The example surveillance server (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example surveillance server (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary surveillance server (152) of FIG. 1 includes a communications adapter (167) that couples the computing device for data communications with other servers in the data center through a data communications network (100). Such a data communication network (100) may be implemented with external buses such as a Universal Serial Bus (‘USB’), or as an Internet Protocol (‘IP’) network or an Ethernet network, an I²C network, a System Management Bus (‘SMBus’), an Intelligent Platform Management Bus (‘IPMB’), for example, and in other ways as will occur to those of skill in the art. Communications adapters implement the hardware level of data communications through which one computer sends data communications to another computer, directly or through a data communications network. Examples of communications adapters useful for controlling a POS terminal using surveillance video according to embodiments of the present invention include modems for wired dial-up communications, Ethernet (IEEE 802.3) adapters for wired data communications network communications and 802.11 adapters for wireless data communications network communications.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

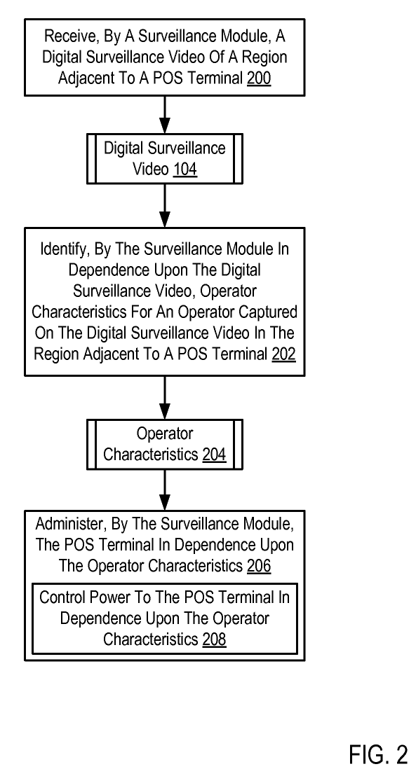

For further explanation, FIG. 2 sets forth a flow chart illustrating an exemplary method of controlling a POS terminal using surveillance video according to embodiments of the present invention. The method of FIG. 2 includes receiving (200), by a surveillance module, a digital surveillance video (104) of a region adjacent to a POS terminal. The digital surveillance video (104) of FIG. 2 is captured by a digital surveillance camera. The digital surveillance camera may be mounted above the POS terminal, on the POS terminal, or in any other manner such that the camera captures the region adjacent to a POS terminal on the digital surveillance video (104).

As mentioned above, the digital surveillance video (104) of FIG. 2 represents a collection of digital frames typically used to create the illusion of a moving picture. The digital surveillance video (104) of FIG. 2 may be captured by the digital surveillance camera according to any number of codecs as will occur to those of skill in the art. Examples of codecs useful in controlling a POS terminal using surveillance video according to embodiments of the present invention may include Cinepak, Motion JPEG, MPEG, and any other codecs as will occur to those of skill in the art.

When the surveillance module is installed on a surveillance server, the surveillance module may receive (200) a digital surveillance video (104) of a region adjacent to a POS terminal according to the method of FIG. 2 by retrieving network packets from the surveillance camera and unencapsulating the digital surveillance video (104) from the network packets. In other embodiments, the surveillance module may receive (200) a digital surveillance video (104) of a region adjacent to a POS terminal according to the method of FIG. 2 by retrieving the digital surveillance video (104) from software installed on a surveillance server that aggregates and administers multiple digital surveillance videos captured by multiple digital surveillance cameras. In still other embodiments where the surveillance module is embedded in the surveillance camera itself and the camera is directly connected to the POS terminal, the surveillance module may receive (200) a digital surveillance video (104) according to the method of FIG. 2 from the codec that generates the digital surveillance video (104).

The method of FIG. 2 also includes identifying (202), by the surveillance module in dependence upon the digital surveillance video (104), operator characteristics (204) for an operator captured on the digital surveillance video (104) in the region adjacent to the POS terminal. As mentioned above, operator characteristics (204) may describe attributes of the operator captured on the digital surveillance video (104) or describe the operator's activity captured on the digital surveillance video. The surveillance module may identify (202), in dependence upon the digital surveillance video (104), operator characteristics (204) for an operator captured on the digital surveillance video (104) according to the method of FIG. 2 using any number of techniques as will occur to those of skill in the art. The surveillance module may identify (202) operator characteristics (204) for an operator according to the method of FIG. 2 by subtracting background data from the frames of the video (104) and comparing the remaining foreground data with a set of predefined patterns that each specify a particular operator characteristic, calculating a confidence level for each comparison, and selecting the operator characteristic associated with the highest confidence level. Background data is information that does not change from frame to frame. As such, background data typically includes image data for the physical environment captured by the surveillance camera. By contrast, the foreground data is information that is typically transient in nature. Foreground data may therefore include image data capturing the operator's movements.

If an operator stops moving for several frames, however, the operator may not appear in the foreground data. As such, the surveillance module may identify (202) operator characteristics (204) for an operator according to the method of FIG. 2 by comparing the entire image data in the frames with a set of predefined patterns that each specify a particular operator characteristic, calculating a confidence level for each comparison, and selecting the operator characteristic associated with the highest confidence level.

The method of FIG. 2 also includes administering (206), by the surveillance module, the POS terminal in dependence upon the operator characteristics (204). The surveillance module administers (206) the POS terminal in dependence upon the operator characteristics (204) according to the method of FIG. 2 by controlling (208) power to the POS terminal in dependence upon the operator characteristics (204). The surveillance module may control (208) power to the POS terminal in dependence upon the operator characteristics (204) according to the method of FIG. 2 by identifying an action from set of action profile using the operator characteristics (204) and performing the identified action. An action profile may associate a particular action to be performed by the surveillance module with certain operator characteristics. For example, an action profile may associate the operator's activity of walking up to the POS terminal with turning on the power to the POS terminal. Similarly, an action profile may associate the operator's activity of walking away from the POS terminal with turning off the power to the POS terminal.

The surveillance module may perform the action identified from a set of action profiles using the operator characteristics (204) by transmitting instructions to the POS terminal according to the identified action. Consider, for example, that action profile associates the operator's activity of walking up to the POS terminal with turning on the power to the POS terminal. Further consider that the surveillance module identifies operator characteristics from the surveillance video specifying that the operator is walking up to the POS terminal. The surveillance module may then transmit instructions to the POS terminal to turn on the power to the POS terminal by transmitting a ‘wakeup’ packet to a powered port on the POS terminal through the network.

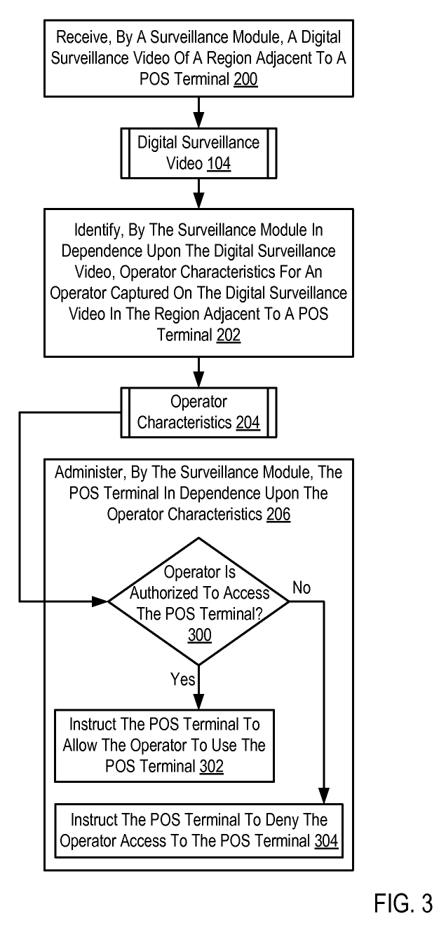

The explanation above with reference to FIG. 2 describes a surveillance module administering the POS terminal by controlling power to the POS terminal. Readers will note, however, that such an administering the POS terminal may be carried out in any number of other ways as will occur to those of skill in the art. For further explanation, therefore, consider FIG. 3 that sets forth a flow chart illustrating a further exemplary method of controlling a POS terminal using surveillance video according to embodiments of the present invention.

The method of FIG. 3 is similar to the method of FIG. 2. That is, the method of FIG. 3 includes: receiving (200), by a surveillance module, a digital surveillance video (104) of a region adjacent to a POS terminal, the digital surveillance video (104) captured by a digital surveillance camera; identifying (202), by the surveillance module in dependence upon the digital surveillance video (104), operator characteristics (204) for an operator captured on the digital surveillance video (104) in the region adjacent to the POS terminal; and administering (206), by the surveillance module, the POS terminal in dependence upon the operator characteristics (204). In the example of FIG. 3, the operator characteristics (204) represent operator attributes captured on the digital surveillance video.

The method of FIG. 3, however, differs from the method of FIG. 2 in that administering (206), by the surveillance module, the POS terminal in dependence upon the operator characteristics (204) includes determining (300) whether the operator is authorized to access the POS terminal in dependence upon the operator characteristics (204). The surveillance module may determine (300) whether the operator is authorized to access the POS terminal according to the method of FIG. 3 by receiving a security token from the operator through the POS terminal, determining whether to authenticate the operator based on the security token and an attribute of the operator captured on the surveillance video, and determining whether to authorize the operator to access the POS terminal if the surveillance module authenticates the operator. The security token may be a username/password combination, security information contained in an employee badge, or any other security token as will occur to those of skill in the art. The surveillance module may determine whether to authenticate the operator based on the security token and an attribute of the operator captured on the surveillance video by performing a first tier of operator authentication based solely on the security token and then performing a second tier of operator authentication based on the operator attribute captured on the surveillance video. The surveillance module may determine whether the operator is authorized to access the POS terminal by looking up the authenticated operator's privileges in an authorization policy and determining whether the authenticated operator is authorized to use the POS terminal based on the authenticated operator's privileges.

For further explanation, consider that the operator attribute describes the type of clothing worn by operator and that the security token is implemented as a username/password combination. In such an example, the surveillance module may determine whether to authenticate the operator based on the security token and an attribute of the operator captured on the surveillance video by performing a first tier of operator authentication based whether the operator provided by the proper username/password combination and then performing a second tier of operator authentication based on whether the operator was wearing an employee uniform. Unless the operator both provides the correct username/password combination and is dressed in an employee uniform, the surveillance module does not authenticate the operator, thereby denying the operator access to the POS terminal.

Although the description above for determining whether the operator is authorized to access the POS terminal uses the operator characteristics as well as security information provided by the operator through the POS terminal, readers will note that such an example is for explanation only and not for limitation. In some embodiments, especially those in which the camera is mounted on the POS terminal, the surveillance module may determine whether the operator is authorized to access the POS terminal based solely on the operator characteristics captured on the surveillance video.

Administering (206), by the surveillance module, the POS terminal in dependence upon the operator characteristics (204) according to the method of FIG. 3 also includes instructing (302) the POS terminal to allow the operator to use the POS terminal if the operator is authorized to access the POS terminal. The surveillance module may instruct (302) the POS terminal to allow the operator to use the POS terminal according to the method of FIG. 3 by sending an ‘access granted’ message to a security client installed on the POS terminal through a data communications connection. The access granted message specifies to the security client installed on the POS terminal that the operator is authorized to access the POS terminal.

Administering (206), by the surveillance module, the POS terminal in dependence upon the operator characteristics (204) according to the method of FIG. 3 also includes instructing (304) the POS terminal to deny the operator access to the POS terminal if the operator is not authorized to access the POS terminal. The surveillance module may instruct (304) the POS terminal to deny the operator access to the POS terminal according to the method of FIG. 3 by sending an ‘access denied’ message to a security client installed on the POS terminal through a data communications connection. The access denied message specifies to the security client installed on the POS terminal that the operator is not authorized to access the POS terminal. In other embodiments where the security client on the POS terminal defaults to denying POS terminal access to the operator, the surveillance module may instruct (304) the POS terminal to deny the operator access to the POS terminal according to the method of FIG. 3 by not providing an ‘access granted’ message to a security client installed on the POS terminal.

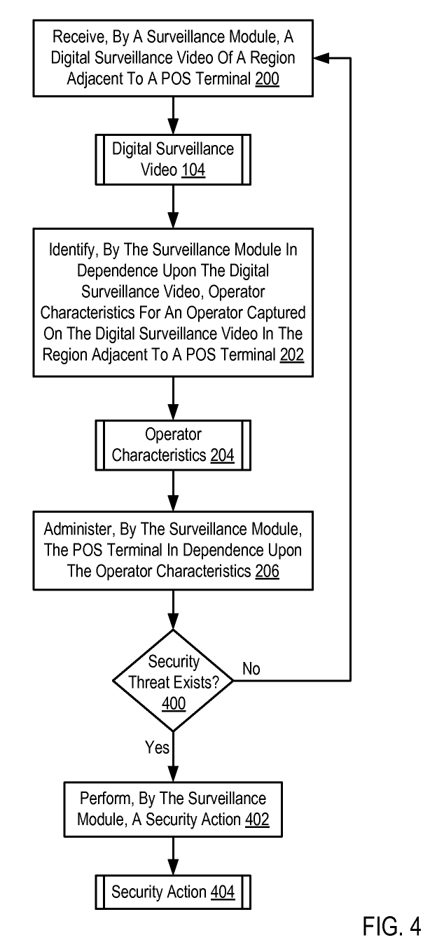

In addition to administering the POS terminal, the surveillance module may also use the operator characteristics captured on the surveillance video to perform other actions, specifically other security actions. A security action is an action performed to increase the security of the POS terminal and the POS terminal's contents. For further explanation, therefore, consider FIG. 4 that sets forth a flow chart illustrating a further exemplary method of controlling a POS terminal using surveillance video according to embodiments of the present invention.

The method of FIG. 4 is similar to the method of FIG. 2. That is, the method of FIG. 4 includes: receiving (200), by a surveillance module, a digital surveillance video (104) of a region adjacent to a POS terminal, the digital surveillance video (104) captured by a digital surveillance camera; identifying (202), by the surveillance module in dependence upon the digital surveillance video (104), operator characteristics (204) for an operator captured on the digital surveillance video (104) in the region adjacent to the POS terminal; and administering (206), by the surveillance module, the POS terminal in dependence upon the operator characteristics (204). In the example of FIG. 4, the operator characteristics (204) represent the operator's activity at the POS terminal captured on the digital surveillance video.

The method of FIG. 4 differs from the method of FIG. 2, however, in that the method of FIG. 4 includes determining (400), by the surveillance module, whether the operator's activity indicates that a security threat exists. The surveillance module may determine (400) whether the operator's activity indicates that a security threat exists by determining whether a particular pattern of motion identified based on the operator's activity matches a security threat activity profile. If a particular pattern of motion identified based on the operator's activity matches a security threat activity profile, then a security threat exists. A security threat does not exist, however, if particular pattern of motion identified based on the operator's activity does not match a security threat activity profile. If the operator's activity indicates that a security threat does not exist, the method of FIG. 4 repeats with the step described above.

A security threat activity profile specifies a particular security threat by associating the particular security threat with a pattern describing the motion of certain aspects of the operator. For example, a security threat activity profile may associate a robbery attempt with the pattern describing the motion of operator raising arms above the operator's head. In another example, a security threat activity profile may associate an employee theft with the pattern describing the motion of operator taking cash from the POS terminal and placing the cash in the operator's pocket.

The method of FIG. 4 also includes performing (402), by the surveillance module, a security action (404) if the operator's activity indicates that a security threat exists. A security action (404) represents an action performed to increase the security of the POS terminal and the POS terminal's contents. For example, a security action may be implemented as an action to trigger a security alarm, an action to automatically disable the POS terminal, an action automatically to lock the POS terminal so the contents cannot be removed, or any other action performed to increase the security of the POS terminal and the POS terminal's contents as will occur to those of ordinary skill in the art. The surveillance module may perform (402) the security action (404) according to the method of FIG. 4 by looking up in a security action table the security action (404) associated with the security threat that exists and executing the identified security action (404).

Exemplary embodiments of the present invention are described largely in the context of a fully functional computer system for controlling a POS terminal using surveillance video. Readers of skill in the art will recognize, however, that the present invention also may be embodied in a computer program product disposed on a computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of controlling a Point Of Sale (‘POS’) terminal using surveillance video, the method comprising:
receiving, by a surveillance module, a digital surveillance video of a region adjacent to a POS terminal, the digital surveillance video captured by a digital surveillance camera;
identifying, by the surveillance module in dependence upon the digital surveillance video, operator characteristics for an operator captured on the digital surveillance video in the region adjacent to the POS terminal; and
administering, by the surveillance module, the POS terminal in dependence upon the operator characteristics.

2. The method of claim 1 wherein administering, by the surveillance module, the POS terminal in dependence upon the operator characteristics further comprises controlling power to the POS terminal in dependence upon the operator characteristics.

3. The method of claim 1 wherein:
the operator characteristics represent attributes for the operator; and
administering, by the surveillance module, the POS terminal in dependence upon the operator characteristics further comprises:
determining whether the operator is authorized to access the POS terminal in dependence upon the operator characteristics, and
instructing the POS terminal to allow the operator to use the POS terminal if the operator is authorized to access the POS terminal.

4. The method of claim 1 wherein:
the operator characteristics represent the operator's activity at the POS terminal; and
the method further comprises:
determining, by the surveillance module, whether the operator's activity indicates that a security threat exists, and
performing, by the surveillance module, a security action if the operator's activity indicates that a security threat exists.

5. The method of claim 1 wherein the digital surveillance camera is mounted above the POS terminal.

6. The method of claim 1 wherein the digital surveillance camera is mounted on the POS terminal.

7. Apparatus for controlling a Point Of Sale (‘POS’) terminal using surveillance video, the apparatus comprising a computer processor, a computer memory operatively coupled to the computer processor, the computer memory having disposed within it computer program instructions capable of:
receiving, by a surveillance module, a digital surveillance video of a region adjacent to a POS terminal, the digital surveillance video captured by a digital surveillance camera;
identifying, by the surveillance module in dependence upon the digital surveillance video, operator characteristics for an operator captured on the digital surveillance video in the region adjacent to the POS terminal; and
administering, by the surveillance module, the POS terminal in dependence upon the operator characteristics.

8. The apparatus of claim 7 wherein administering, by the surveillance module, the POS terminal in dependence upon the operator characteristics further comprises controlling power to the POS terminal in dependence upon the operator characteristics.

9. The apparatus of claim 7 wherein:
the operator characteristics represent attributes for the operator; and
administering, by the surveillance module, the POS terminal in dependence upon the operator characteristics further comprises:
determining whether the operator is authorized to access the POS terminal in dependence upon the operator characteristics, and
instructing the POS terminal to allow the operator to use the POS terminal if the operator is authorized to access the POS terminal.

10. The apparatus of claim 7 wherein:
the operator characteristics represent the operator's activity at the POS terminal; and
the computer memory has disposed within it computer program instructions capable of:
determining, by the surveillance module, whether the operator's activity indicates that a security threat exists, and
performing, by the surveillance module, a security action if the operator's activity indicates that a security threat exists.

11. The apparatus of claim 7 wherein the digital surveillance camera is mounted above the POS terminal.

12. The apparatus of claim 7 wherein the digital surveillance camera is mounted on the POS terminal.

13. A computer program product for controlling a Point Of Sale (‘POS’) terminal using surveillance video, the computer program product disposed in a computer readable medium, the computer program product comprising computer program instructions capable of:
receiving, by a surveillance module, a digital surveillance video of a region adjacent to a POS terminal, the digital surveillance video captured by a digital surveillance camera;
identifying, by the surveillance module in dependence upon the digital surveillance video, operator characteristics for an operator captured on the digital surveillance video in the region adjacent to the POS terminal; and
administering, by the surveillance module, the POS terminal in dependence upon the operator characteristics.

14. The computer program product of claim 13 wherein administering, by the surveillance module, the POS terminal in dependence upon the operator characteristics further comprises controlling power to the POS terminal in dependence upon the operator characteristics.

15. The computer program product of claim 13 wherein:
the operator characteristics represent attributes for the operator; and
administering, by the surveillance module, the POS terminal in dependence upon the operator characteristics further comprises:
determining whether the operator is authorized to access the POS terminal in dependence upon the operator characteristics, and
instructing the POS terminal to allow the operator to use the POS terminal if the operator is authorized to access the POS terminal.

16. The computer program product of claim 13 wherein:
the operator characteristics represent the operator's activity at the POS terminal; and
the computer program product further comprises computer program instructions capable of:
determining, by the surveillance module, whether the operator's activity indicates that a security threat exists, and
performing, by the surveillance module, a security action if the operator's activity indicates that a security threat exists.

17. The computer program product of claim 13 wherein the digital surveillance camera is mounted above the POS terminal.

18. The computer program product of claim 13 wherein the digital surveillance camera is mounted on the POS terminal.

19. The computer program product of claim 13 wherein the computer readable medium comprises a recordable medium.

20. The computer program product of claim 13 wherein the computer readable medium comprises a transmission medium.
